(19) United States
(12) Patent Application Publication
(10) Pub. No.: US 2013/0051788 A1
(43) Pub. Date: Feb. 28, 2013

(54) PATH DISCOVERY IN A COMMUNICATIONS NETWORK

(71) Applicants: Carla Marcenaro, Genoa (IT); Giuseppe Burgarella, Genoa (IT)

(72) Inventors: Carla Marcenaro, Genoa (IT); Giuseppe Burgarella, Genoa (IT)

(73) Assignee: TELEFONAKTIEBOLAGET L M ERICSSON (PUBL), STOCKHOLM (SE)

(21) Appl. No.: 13/512,317

(22) PCT Filed: Nov. 26, 2009
(86) PCT No.: PCT/EP2009/065884

§ 371 Date: Oct. 1, 2012

(51) Int. Cl. H04B 10/08

(52) U.S. Cl. 398/16

(57) ABSTRACT

The invention relates to discovering a path in a communications network. Embodiments of the invention disclose determining whether at least two server trail termination points (TTPs) of the path are compatible, creating a server trail between the at least two TTPs, determining whether each TTP is framed by a respective client connection termination point (CCTP) of a higher layer, assigning a respective CCTP to each of the two TTPs, creating a link connection between the respective CCTPs, determining if one of the respective CCTPs is associated with a higher layer TTP, and if it is not so associated then determining if one of the respective CCTPs is constrained to a single TTP. The embodiments of the invention allow paths in a network to be determined after a change has taken place or a physical link has been created.

### TECHNICAL FIELD

The invention relates to a method and an apparatus for discovering a path in a communications network.

### BACKGROUND

According to the Open System Interconnection (OSI) seven layer model a transport network can be decomposed into a plurality of independent transport networks operating at different layers. Each independent transport network has a client/server relationship with networks in adjacent layers, and may be operated in a way which reflects the internal structure of the network or the way that it will be managed. An example of such a relationship is the carrying of different payloads across multiple networks such as carrying Plesiochronous Digital Hierarchy (PDH) data streams over Synchronous Digital Hierarchy (SDH) frames, which are then carried over an Optical Transport Network (OTN).

A considerable effort is spent to build server paths in each transport layer of the OSI model to configure the communications network. Such effort is required when the communications network is commissioned for the first time, or when there has been a change in the communications network such as a new or amended physical connection. Using the above example, it is necessary to determine an Optical Data Unit (ODU) path in the OTN before determining the path in a SDH network. Similarly the path in the SDH network must be determined before the path in a PDH network. The objective of building server paths is to avoid conflicts, and to optimise overall network efficiency when configuring the communications network.

Determination of paths requires considerable resources and time. Typically the determination of paths is performed with the assistance of a network manager apparatus which may be a server with a global view of the network, and which is operated with network manager software. A network operator typically makes manual connections in a transport network at different layers of the OSI seven layer model, such as a physical connections at layer one, an Optical Channel (OCH) connection at layer four, and an ODU connection at layer six. The OCH connection and the ODU connection may be made by manual input of trail objects in a database of the network manager apparatus.

The network manager apparatus is then operated to see if the overall path through the network is possible and that there are no conflicts with other paths. Such a process may need to be repeated many times to obtain an optimised configuration for the network.

Repeating this process to manually change the OCH connections and the ODU connections may take a long time to perform which is inefficient way of configuring the network.

### SUMMARY

It is desirable to provide a way of readily determining paths and connections in a communications network, and to reduce at least some of the above-mentioned problems.

According to a first aspect of the invention, there is provided a method for discovering a path in a communications network. The method including determining whether at least two server trail termination points of the path are compatible. The method including creating a server trail between the at least two trail termination points. The method including determining whether each trail termination point is framed by a respective client connection termination point of a higher layer. The method including assigning a respective client connection termination point to each of the two trail termination points. The method including creating a link connection between the respective client connection termination points. The method including determining if one of the respective client connection termination points is associated with a higher layer trail termination point. The method including, if it is not so associated, determining if one of the respective client connection termination points is constrained to a trail termination point.

Such a method permits at least one end of a path in the communications network to be determined, and provides the advantage of avoiding the need to repeat the process of manually changing connections in the communications network to determine the path. The method is applicable to a general scenario in the communications network when the communications network is configured for the first time, or when there has been a change in the communications network. The method changes the approach to configuring the communications network, whereby the path is determined and built up iteratively instead of manually making changes in the communications network and determining if the path results in a conflict. Overall the method provides a greatly improved way for discovering a path in the communications network by reducing effort and increasing the efficiency with which the path is determined.

Further features of the invention are as claimed in the dependent claims.

According to a second aspect of the invention there is provided a network manager apparatus for discovering a path in a communications network having a processor. The processor adapted to perform the function of determining whether at least two server trail termination points of the path are compatible. The processor adapted to perform the function of creating a server trail between the at least two trail termination points. The processor adapted to perform the function of determining whether each trail termination point is framed by a respective client connection termination point of a higher layer. The processor adapted to perform the function of assigning a respective client connection termination point to each of the two trail termination points. The processor adapted to perform the function of creating a link connection between the respective client connection termination points. The processor adapted to perform the function of determining if one of the respective client connection termination points is associated with a higher layer trail termination point. If it is not so associated then the processor is adapted to perform the function of determining if one of the respective client connection termination points is constrained to a trail termination point.

Further features of the invention are as claimed in the dependent claims.

According to a third aspect of the invention there is provided a computer program product operable to perform the method according to the first aspect of the invention.

According to a fourth aspect of the invention there is provided a communications network operable to perform the method according to the first aspect of the invention, or including a network manager apparatus according to the second aspect of the invention.

### BRIEF DESCRIPTION OF THE DRAWINGS

Features of the invention will be apparent from the following description of preferred embodiments shown by way of example only with reference to the accompanying drawings, in which;

FIG. 1 shows a diagram of a communications network to describe embodiments of the invention;

FIG. 2 is a flow diagram illustrating a method according to an embodiment of the invention;

FIG. 3 is a schematic diagram showing implementations of the method of FIG. 2 according to an embodiment of the invention; and

FIG. 4 is a schematic diagram showing an implementation of the method of FIG. 2 according to an embodiment of the invention.

### DETAILED DESCRIPTION

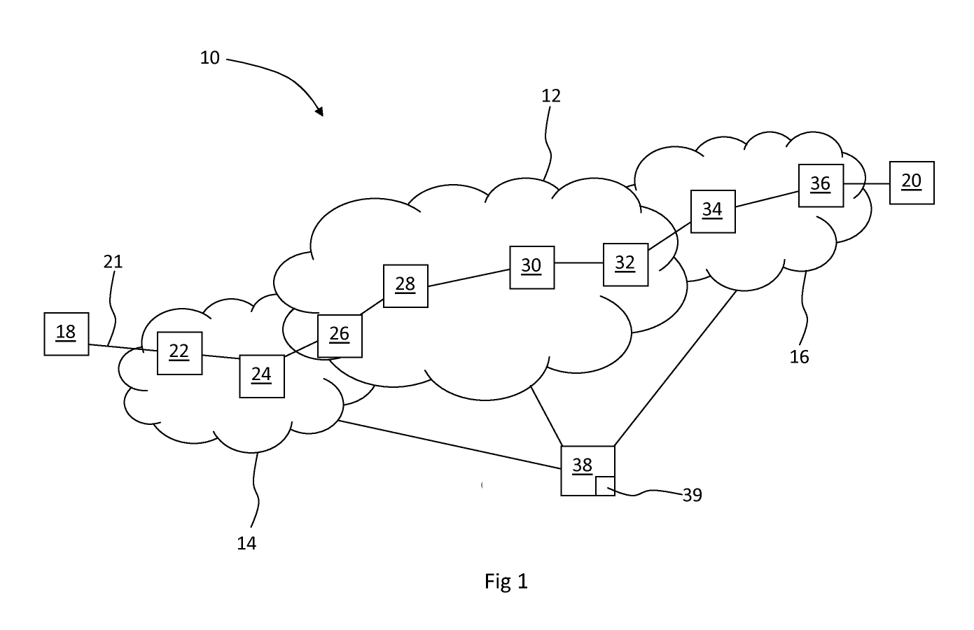

FIG. 1 shows a diagram of a communications network used as a reference to describe embodiments of the invention, generally designated 10. In FIG. 1 the communications network 10 comprises a core Dense Wavelength Division Multiplexing (DWDM) network 12 which is between first and second Synchronous Digital Hierarchy (SDH) networks labelled 14, 16. For a node 18 in communication with the first SDH network 14 to communicate with a node 20 in communication with the second SDH network 16, a path 21 must be determined through the first SDH network 14, through the DWDM network 12, and through the second SDH network 16. The path 21 is shown to comprise nodes 22, 24 of the first SDH network 14, nodes 26, 28, 30, 32 of the DWDM network 12, and nodes 34, 36 of the second SDH network 16. The overall setup of the network 10 is controlled by a network manager apparatus 38 which is a server with network software, and which is programmed to operate to perform the method according to the embodiment described below. The apparatus 38 may have a graphical user interface for operation and implementation of the method described below. The nodes 18, 20, 22, 24, 26, 28, 30, 32, 34, 36 may alternatively be known as Network Elements (NEs).

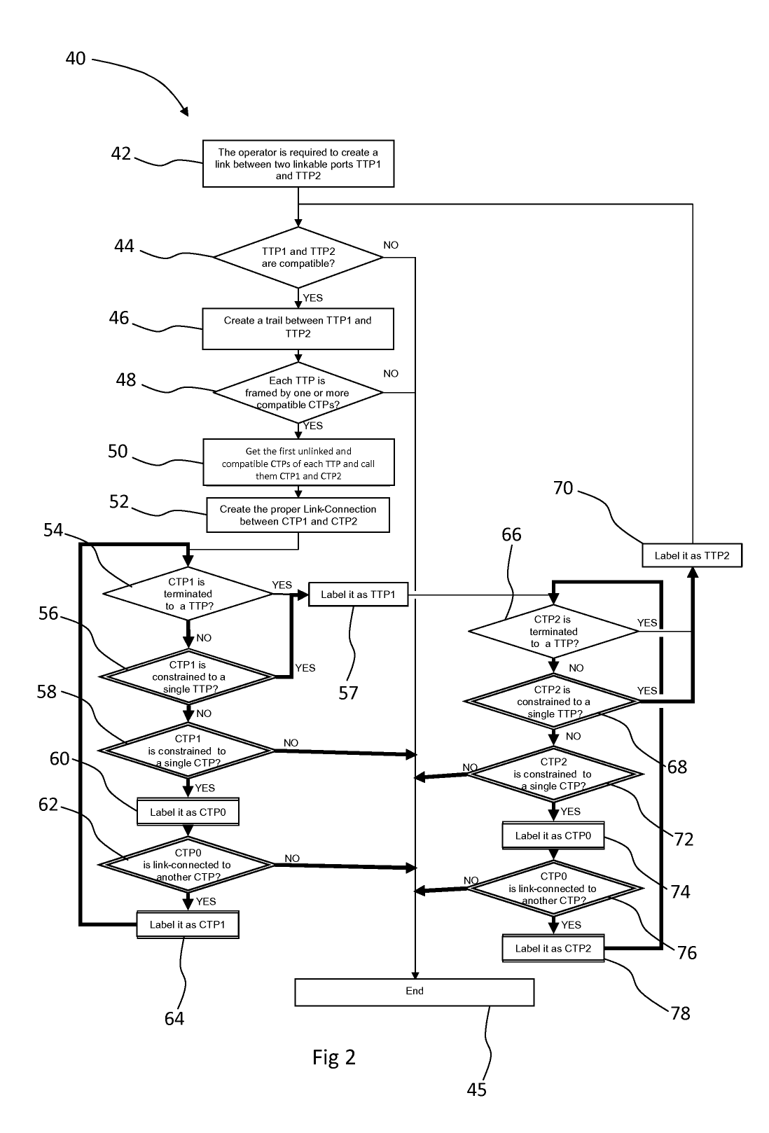

FIG. 2 is a flow diagram illustrating a method according to an embodiment of the invention, generally designated 40. In the flow diagram, the concepts of server Trail Termination Points (TTPs) and client Connection Termination Points (CTPs) are used which are further defined in the International Telecommunications Union standard G.774. The flow diagram also uses the terms “compatible”, “terminated”, and “constrained” which are further defined in the standards ITU-T G.709 and G.872. In this specification the word “path” is used in a general sense to describe a series connections or links through the network 10. The term “trail” is used to describe connections between TTPs.

The method 40 describes a way of discovering a path in a communications network. The start of the method 40 is shown at 42 where an operator of the network 10 is required to create a link between two ports of respective Network Elements (NEs) that are linkable. The two ports are server TTPs and are labelled as TTP1 and TTP2, and the method initially determines whether these server TTPs of the path are compatible, as shown as 44. The TTPs labelled as TTP1 and TTP2 will be compatible for a link when all of their associated technology constraints are satisfied such as their signal types, bit rates etc.

If TTP1 and TTP2 are not compatible the method proceeds to box 45 which shows that the method ends. If TTP1 and TTP2 are compatible the method proceeds to create a trail between TTP1 and TTP2 as shown at 46. The trail may eventually form part of the path, and the trail may be a trail object in an object table of the network manager apparatus 38 shown in FIG. 1. Such a trail object contains data about the ports which form TTP1 and TTP2, the power requirements of the ports for TTP1 and TTP2, how many NEs or

Local Area Networks (LANs) are between TTP1 and TTP2, or other parameters. The trail object models the link in terms of parameters that define the link.

The method then determines whether each of TTP1 and TTP2 are compatible with one or more client CTPs as shown at 48. A server TTP is compatible if it is framed by one or more client CTPs. For example, a Virtual Container VC4 can be framed into three TU3 packets. In this regard a client CTP can be thought of as a model for packaging data for a server TTP. If each of TTP1 and TTP2 are not compatible the method continues to box 45 which shows that the method ends.

The method then obtains the first unlinked and compatible client CTPs for each of TTP1 and TTP2 and assigns or labels them as CTP1 and CTP2 respectively, as shown at 50. Two CTPs are compatible for a link connection if all their technology constraints are satisfied, such as their timeslots, frequencies etc.

The method then creates a link connection between CTP1 and CTP2, as shown at 52. The method then determines if CTP1 is terminated to a higher layer server TTP, as shown at 54. Such termination may be an association with the higher layer TTP, which relates to the availability of bandwidth. If CTP1 is not associated with a higher layer server TTP the method then determines if CTP1 is constrained to a single server TTP, as shown at 56. A client CTP is constrained to a server TTP if it satisfies a set of rules defined by a routing algorithm. Such a constraint may be thought of as an affiliation or an assignment to another TTP. After step 56 one end of the path is known and the method 40 can be stopped if required. Knowing one end of the path means that at least a part of the path has been discovered, which is a useful step in the process of path discovery of the complete path.

If CTP1 is constrained to a single server TTP, the method continues by assigning the single server TTP as a server TTP of the path, as shown at 57 which shows that it is reassigned or labelled as TTP1. After step 54, if it is determined that CTP1 is terminated to a higher layer server TTP, the method continues by assigning the higher layer server TTP as a TTP of the path, as shown at 57 which shows that it is reassigned or labelled as TTP1. It will be appreciated that TTP1 could be compatible with another TTP in the same layer and on another NE, and so could cause the creation of another trail.

After step 56, if it is determined that CTP1 is not constrained to a single server TTP, the method continues by determining if CTP1 is constrained to a single client CTP in the same layer, as shown at 58. A client CTP is constrained to another client CTP if it satisfies a set of rules defined by a routing algorithm. Such a constraint may be thought of as an affiliation or an assignment to another CTP. If CTP1 is not constrained to a single client CTP then no further connections can be created which means that the task of creating all of the trails and link connections to model the link is ended, as shown at 45, which means that all trail creation is stopped. If CTP1 is constrained to a single client CTP the method continues by labelling the single CTP as CTP0 as shown at 60. The method then continues by determining if CTP0 is linked to another client CTP, as shown at 62. If CTP0 is not so linked then no further connections can be created which means that the task of creating all of the trails and link connections to model the link is ended, as shown at 45, which means that all trail creation is stopped. If CTP0 is linked to another CTP the method then assigns or labels the other CTP as CTP1, as shown at 64. It will be appreciated that the method is extendible to situations where CTP0 is constrained to many CTPs. The method then returns and continues from step 54.

After step 57, the method then determines if CTP2 is terminated to a higher layer server TTP, as shown at 66. If CTP2 is not associated with a higher layer server TTP the method then determines if CTP2 is constrained to a single server TTP, as shown at 68. If CTP2 is constrained to a single server TTP, the method continues by assigning or labelling the single server TTP as a server TTP of the path, as shown at 70 which shows that it is reassigned as TTP2. After step 66, if it is determined that CTP2 is terminated to a higher layer server TTP, the method continues by assigning or labelling the higher layer server TTP as a TTP of the path, as shown at 70 which shows that it is reassigned as TTP2. It will be appreciated that TTP2 could be compatible with another TTP in the same layer and on another NE, and so could cause the creation of another trail.

After step 68, if it is determined that CTP2 is not constrained to a single server TTP, the method continues by determining if CTP2 is constrained to a single client CTP in the same layer, as shown at 72. If CTP2 is not constrained to a single client CTP then no further connections can be created which means that the task of creating all of the trails and link connections to model the link is ended, as shown at 45, which means that all trail creation is stopped. If CTP2 is constrained to a single client CTP the method continues by labelling the single CTP as CTP0 as shown at 74. The method then continues by determining if CTP0 is linked to another client CTP, as shown at 76. If CTP0 is not so linked then no further connections can be created which means that the task of creating all of the trails and link connections to model the link is ended, as shown at 45, which means that all trail creation is stopped. If CTP0 is linked to another CTP the method then assigns or labels the other CTP as CTP2, as shown at 78. It will be appreciated that the method is extendible to situations where CTP0 is constrained to many CTPs. The method then returns and continues from step 66. After step 70, the method then returns and continues from step 44.

It will be appreciated that the method 40 may be implemented by the network manager apparatus 38 shown in FIG. 1. The network manager apparatus having a processor 39 adapted to perform the functions of the method 40. Whereas the method shown in FIG. 2 refers to constraint to a single trail termination point and constraint to a single client termination point it will be understood that the method may be extended to multi-termination point constraints.

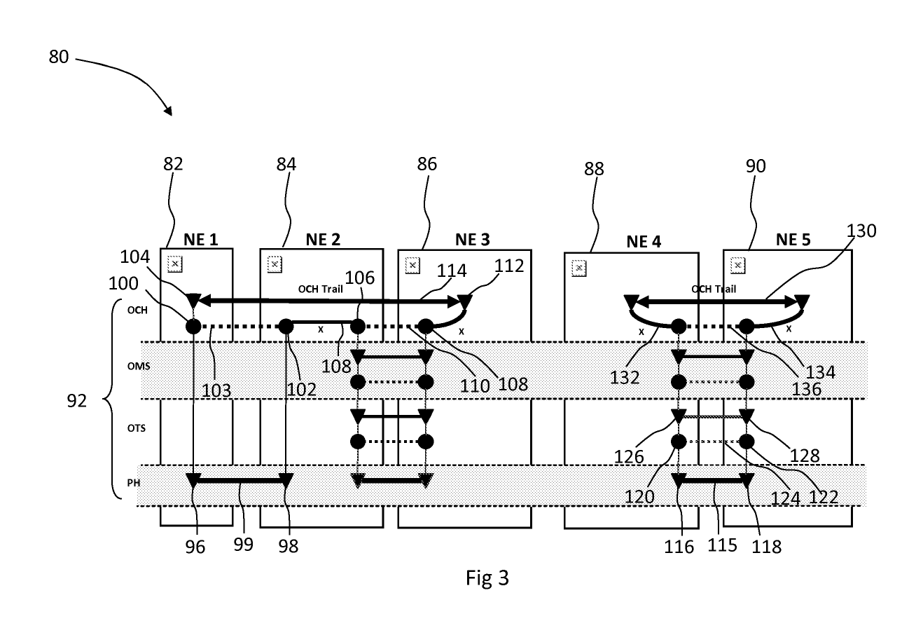

FIG. 3 is a schematic diagram, generally designated 80, showing implementations of the method of FIG. 2 according to an embodiment of the invention. In FIG. 3 five NEs are shown at 82, 84, 86, 88, 90. Four layers of the Open System Interconnection (OSI) seven layer model of the five NEs 82, 84, 86, 88, 90 are also shown at 92. The four layers 92 include the Physical layer labelled as PH, the Data Link layer labelled as OTS (Optical Transport Section), the Network layer labelled as OMS (Optical Multiplex Section), and the Transport layer labelled as OCH (Optical Channel). In FIG. 3 the triangles represent server TTPs and the circles represent client CTPs.

The method 40 of FIG. 2 will now be described with reference to FIG. 3 to describe how paths are discovered in a network using the method 40. The method starts at 42 when the network operator is required to create a link between two linkable ports 96, 98 of the NEs 82, 84. The ports 96, 98 are the current server TTPs and are labelled as TTP1 and TTP2 respectively. The method continues at 44 by determining if TTP1 and TTP2 are compatible. Since they are compatible, the method continues at 46 to create the trail labelled as 99. The method continues at 48 to determine whether each of TTP1 and TTP2 are framed by one or more compatible client CTPs. The method then continues at 50 by obtaining the first unlinked and compatible client CTPs for each of TTP1 and TTP2 and assigns them as CTP1 and CTP2 which are shown at 100 and 102 respectively in the OCH layer. The method then continues at 52 to create a link 103 between CTP1 and CTP2. The method then continues at 54 to determine if CTP1 shown at 100 is terminated to a higher layer server TTP. Since CTP1 is terminated to a higher layer server TTP shown at 104, the method continues at 57 by assigning the higher layer server TTP, shown at 104, as a TTP of the path, whereby it is reassigned as TTP1.

The method then continues at 66 to determine if CTP2 shown at 102 is terminated to a higher layer server TTP. Since CTP2 shown at 102 is not associated with a higher layer server TTP the method then continues to 68 to determine if CTP2 shown at 102 is constrained to a single server TTP. Since CTP2 shown at 102, is not constrained to a single server TTP, the method continues at 72 to determine if CTP2 shown at 102 is constrained to a single client CTP in the same layer. Since CTP2 shown at 102 is constrained to a single CTP shown at 106 via a cross connect shown at 108, the method continues at 74 by labelling the single CTP shown at 106 as CTP0. The method then continues at 76 to determine if CTP0 is linked to another client CTP. Since CTP0 is linked to another CTP shown at 108 via a link 110, the method then continues at 78 to assign the other CTP shown at 108 as CTP2. The method then continues from step 66 to determine if CTP2 shown at 108 is terminated to a higher layer server TTP. Since CTP2 shown at 108 is constrained via a cross connection to a single server TTP shown at 112, the method continues at 70 by assigning the single server TTP shown at 112 as a server TTP of the path, whereby the single server TTP shown at 112 is reassigned as TTP2. The method then continues to step 44 to determine whether the server TTPs of the path labelled at TTP1 at 104 and TTP2 at 112 are compatible. Since they are compatible, the method continues at 46 to create a path 114 between TTP1 at 104 and TTP2 at 112 which is the OCH trail in the OCH layer as shown at 46. The method then continues at 48 to determine whether each of TTP1 at 104 and TTP2 at 112 are framed with one or more client CTPs. Since TTP1 at 104 and TTP2 at 112 are not framed by one or more client CTPs the method ends at 45.

It will be appreciated that once the physical link 99 has been created by a network operator, the various links and connections through the four layers 92 of the three NEs 82, 84, 86 are created by following the method 40. Accordingly, the network operator must only perform connection of the physical link 99 for links in various layers 92 of the network to be automatically created.

Another implementation of the method 40 is shown with reference to the NEs 88, 90 in FIG. 3. The method starts at 42 when the network operator is required to create the link 115 between two linkable ports 116, 118 of the NEs 88, 90. The ports 116, 118 are the current server TTPs and are labelled as TTP1 and TTP2 respectively. The method continues at 44 by determining if TTP 1 shown at 116 and TTP2 shown at 118 are compatible. Since TTP1 shown at 116 and TTP2 shown at 118 are compatible the method continues at 46 to create the link labelled as 115. The method continues at 48 to determine whether each of TTP 1 and TTP2 shown at 116, 118 are framed by one or more compatible client CTPs. The method then continues at 50 by obtaining the first unlinked and compatible client CTPs for each of TTP1 and TTP2 shown at 116 and 118 and assigns them as CTP1 and CTP2 shown at 120 and 122 respectively in the OTS layer.

The method then continues at 52 to create a link 124 between CTP1 and CTP2 shown at 120, 122. The method then continues at 54 to determine if CTP1 shown at 120 is terminated to a higher layer server TTP. Since CTP1 shown at 120 is terminated to a higher layer server TTP shown at 126, the method continues at 57 by assigning the higher layer server TTP, shown at 126, as a TTP of the path, whereby it is reassigned as TTP1.

The method then continues at 66 to determine if CTP2 shown at 122 is terminated to a higher layer server TTP. Since CTP2 shown at 122 is terminated to a higher layer server TTP shown at 128, the method continues at 70 by assigning the higher layer server TTP shown at 128 as a server TTP of the path, whereby the higher layer server TTP shown at 128 is reassigned as TTP2. The method 40 continues in this manner until all of the connections in all of the layers from PH to OCH are generated. It will be appreciated that applying the method 40 causes the OCH server trail shown at 130 to be created because the connections 132, 134, 136 are created.

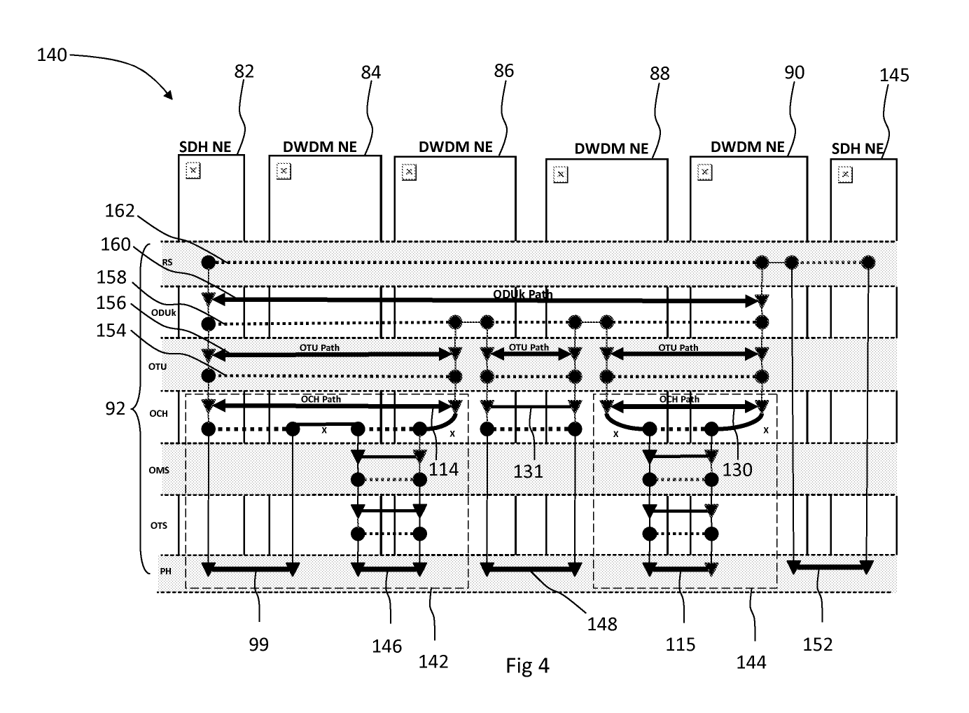

FIG. 4 is a schematic diagram showing an implementation of the method of FIG. 2 according to an embodiment of the invention, generally designated 140. In FIG. 4 like features to the arrangements of FIG. 3 are shown with like reference numerals. In FIG. 4 the arrangements of FIG. 3 are shown in the boxes 142 and 144. FIG. 4 includes an additional NEs labelled as 145, and shows three additional layers of the OSI seven layer model shown at 92. The three additional layers are labelled as OTU (Optical Transport Unit), ODUk (Optical Data Unit of type k), and RS (Regenerator Section).

FIG. 4 shows the advantages of the method 40 in a more complex scenario where the physical links 99, 146, 148, 115 and 152 are required to be created. The method 40 causes the links in boxes 142, 144 to be created as described above with reference to FIG. 3. In FIG. 4 the network manager apparatus 38 applies the method 40 and creates the three OCH paths 114, 130, 131. After that, the network manager apparatus 38 applies the method 40 and creates the three OTU link connections shown at 154, the three OTU trail shown at 156, and the three ODUk link connections shown at 158. The network manager apparatus 38 then applies the method 40 and follows the three of ODUk link connections 158 to determine an ODU path shown at 160. An RS link connection shown at 162 is then created by applying the method 40 which ends on the two NEs 82, 145.

It will be appreciated that after the network operator has created the five physical links 99, 146, 148, 115, 152 the available paths in the whole network 140 can be discovered by applying the method 40 using a network manager apparatus 38. Accordingly only the five physical links 99, 146, 148, 115, 152 are required to be created for configuration of the whole network 140. In the example of FIG. 4, the method 40 automatically discovers the three OCH paths 114, 131, 130, and the one ODU path 160.

It will also be appreciated that to determine the available paths in the whole network 10 without applying the method 40 using the techniques of the prior art, the network operator would need to create the five physical links 99, 146, 148, 115, 152, and would need to manually create three OCH paths 114, 131, 130, and also would need to manually create the one ODU path 160. The advantage of the method 40 according to the embodiments of the invention are a large reduction in the amount of time and effort required for network configuration by the network operator. Furthermore, because the

OCH paths 114, 130, 131 are discovered using the method 40, the required interaction with the network from the network operator is reduced, which leads to an improvement in efficiency for configuration of the network 10.

Whereas simple examples of implementing the method 40 have been described herein with reference to FIGS. 3 and 4, it will be understood that a real life network would be much more complex. Accordingly, using the method 40, the time and effort to configure such a real life network would be greatly reduced. Using the method 40, the network operator is provided with a much more efficient tool for configuring the network 10 when compared to the prior art.

The embodiments of the invention described herein may also be able to provide an improved operation and maintenance for the network 10 if the network 10 is changed and requires reconfiguration. The method 40 may be thought of as a discovery engine to determine paths in a network 10 after a physical link has been created or removed. In a general sense the method 40 operates to input trail objects in a database which relate to the paths in the network 10. Such trail objects would otherwise need to be manually created by a network operator when configuring the network 10.

1. A method for discovering a path in a communications network, including:
determining that at least two server trail termination points of the path are compatible;
creating a server trail between the at least two trail termination points;
determining that each trail termination point is framed by a respective client connection termination point of a higher layer;
assigning a respective client connection termination point to each of the two trail termination points;
creating a link connection between the respective client connection termination points;
determining if one of the respective client connection termination points is associated with a higher layer trail termination point; and
if the one of the respective client connection termination points is not so associated then performing the following:
a) determining if the one of the respective client connection termination points is constrained to a trail termination point.

2. A method according to claim 1 and further including after step a):
b) if the one of the respective client connection termination points is constrained then assigning the trail termination point as a trail termination point of the path.

3. A method according to claim 1 and further including after step a):
c) if the one of the respective client connection termination points is not so constrained then determining if the one of the respective client connection termination points is constrained to a client connection termination point in the same layer.

4. A method according to claim 3 and further including after step c):
d) if the one of the respective client connection termination points is not constrained to a client connection termination point then stopping creation of the server trail.

5. A method according to claim 3 and further including after step c):
e) if the one of the respective client connection termination points is constrained to a client connection termination point then determining if the client connection termination point is linked to another client connection termination point.

6. A method according to claim 5 and further including after step e):
f) if the client connection termination point is not so linked then stopping creation of the server trail.

7. A method according to claim 5 and further including after step e):
g) if the client connection termination point is so linked then assigning the another client connection termination point as one of the respective client connection termination points.

8. A method according to claim 7 and further including after step g):
h) determining if the other of the respective client connection termination points is associated with a higher layer trail termination point.

9. A method according to claim 8 and further including after step h):
i) if the other of the respective client connection termination points is so associated then assigning the higher layer trail termination point as a trail termination point of the path.

10. A method according to claim 9 and further including after step i):
j) determining whether each trail termination point is framed by a respective client connection termination point of a higher layer.

11. A method according to claim 10 and further including after step j):
k) if the trail termination points are not so framed then stopping creation of the server trail.

12. A method according to claim 8 and further including after step h):
l) if the other of the respective client connection termination points is not so associated then determining if the other of the respective client connection termination points is constrained to a trail termination point.

13. A method according to claim 12 and further including repeating the steps a)-g) of the method.

14. A network manager apparatus for discovering a path in a communications network, the network manager apparatus including:
a processor adapted to perform the following functions:
determine whether at least two server trail termination points of the path are compatible;
create a server trail between the at least two trail termination points;
determine whether each trail termination point is framed by a respective client connection termination point of a higher layer;
assign a respective client connection termination point to each of the two trail termination points;
create a link connection between the respective client connection termination points;
determine if one of the respective client connection termination points is associated with a higher layer trail termination point; and if the one of the respective client connection termination points is not so associated then perform the following:
a) determine if the one of the respective client connection termination points is constrained to a trail termination point.

15. (canceled)

16. The network manager of claim 14, wherein the processor is further adapted to:
b) if the one of the respective client connection termination points is constrained to a trail termination point, then assign the trail termination point as a trail termination point of the path; and
c) if the one of the respective client connection termination points is not constrained to a trail termination point, then determine if the one of the respective client connection termination points is constrained to a client connection termination point in the same layer.

17. The network manager of claim 16, wherein the processor is further adapted to:
d) if the one of the respective client connection termination points is not constrained to a client connection termination point, then stop creation of the server trail; and
e) if the one of the respective client connection termination points is constrained to a client connection termination point, then determine if the client connection termination point is linked to another client connection termination point.

18. The network manager of claim 17, wherein the processor is further adapted to:
f) if the client connection termination point is not linked to another client connection termination point, then stop creation of the server trail; and
g) if the client connection termination point is linked to another client connection termination point, then assign the another client connection termination point as one of the respective client connection termination points.

19. The network manager of claim 18, wherein the processor is further adapted to:
h) determine if the other of the respective client connection termination points is associated with a higher layer trail termination point.

20. The network manager of claim 19, wherein the processor is further adapted to:
i) if the other of the respective client connection termination points is associated with a higher layer trail termination point, then assign the higher layer trail termination point as a trail termination point of the path;
j) determine whether each trail termination point is framed by a respective client connection termination point of a higher layer; and
k) if the trail termination points are not framed by respective client connection termination points, then stop creation of the server trail.

21. The network manager of claim 19, wherein the processor is further adapted to:
l) if the other of the respective client connection termination points is not associated with a higher layer trail termination point, then determine if the other of the respective client connection termination points is constrained to a trail termination point.
